(19) United States
(12) Patent Application Publication
(10) Pub. No.: US 2015/0050082 A1
(43) Pub. Date: Feb. 19, 2015

(54) PART INSTALLATION STRUCTURE

(71) Applicants: Tatsunori Goto, Tokyo (JP); Norimitsu Hasegawa, Amagasaki-shi (JP)

(72) Inventors: Tatsunori Goto, Tokyo (JP); Norimitsu Hasegawa, Amagasaki-shi (JP)

(73) Assignee: MITSUBISHI ELECTRIC CORPORATION, Tokyo (JP)

(21) Appl. No.: 14/385,937

(22) PCT Filed: Jun. 29, 2012
(86) PCT No.: PCT/JP2012/066740

§ 371 Date: Sep. 17, 2014

(51) Int. Cl. F16B 5/10

(52) U.S. Cl. CPC F16B 5/10
USPC 403/361

(57) ABSTRACT

A part installation structure includes: a tongue piece 3 formed such that a sheet-shaped tongue piece provided in a sheet metal part 1 is bent at approximately a right angle to a base connected to the sheet metal part 1; a tongue piece 4 formed such that an approximately L-shaped tongue piece extended from the ends of an installation surface of a sheet metal part 2 is bent at approximately a right angle to the installation surface; and a projection part 2a that is provided, on either the installation surface of the sheet metal part 2 or the tongue piece 3, and that is brought into contact with an opposed surface to apply a pressure thereto when the sheet metal part 1 is installed to the sheet metal part 2 by sandwiching the tongue piece 3 between the installation surface of the sheet metal part 2 and the tongue piece 4.

### TECHNICAL FIELD

The present invention relates to a part installation structure that has installation members made of sheet metal.

### BACKGROUND ART

Conventionally, as structures for mutually installing parts by means of an installation member made of sheet metal, generally, there have been many structures that use fastening parts such as screw members. In these structures, it is necessary to apply fastening processing such as burring and tapping to installation members for each part, and a fastening work needs to be performed while aligning each other's screw holes by using tools or by hand. That is, in addition to molding of a sheet metal member, a precise fastening operation is necessary, and the fastening parts such as screw members need to be prepared separately. Further, to perform the fastening, it is necessary to maintain a state in which the screw holes are matched together, and thus, there has been a limit to the handling during the installation.

As a conventional installation structure that does not use the fastening parts, there is the one as disclosed in Patent Document 1, for example. The installation structure described in this document includes: parts having installation members which are formed with positioning projections and tongue pieces; and parts having installation members which are formed with positioning holes and cut-and-erected members, and when fitting the positioning projections to the positioning holes, the tongue pieces are fitted into insertion holes formed by the cut-and-erected members, and then fixed.

### PRIOR ART DOCUMENTS

### Patent Documents

Patent Document 1: Japanese Patent Application Laid-open No. 2010-272820

### SUMMARY OF THE INVENTION

### Problems to be Solved by the Invention

In the installation structure using the fastening parts, the fastening processing is necessary and essential, in addition to the forming of the sheet metal member, and it is necessary to separately prepare the fastening parts such as screw members. Further, in the fastening work, it is necessary to maintain the state that the screw holes are matched together, and thus, there has been the limit to the handling during the installation.

In the conventional art represented by Patent Document 1, the fastening parts are not required, and the installation can be performed by only fitting the tongue pieces into the insertion holes.

However, the tongue pieces fitted into the insertion holes are merely overlapped with the cut-and-erected pieces, and stable fixing is not performed. Therefore, there is a possibility that backlash occurs after the installation.

The present invention has been made to solve the foregoing problems, and an object of the invention is to provide a part installation structure capable of stably installing the parts to each other without using the fastening parts.

### Means for Solving the Problems

According to a part installation structure of the present invention, a part installation structure for installing a first part to a second part includes: a first tongue piece formed such that a sheet-shaped tongue piece provided in the first part is bent at approximately a right angle with respect to abase that is connected to the first part; a second tongue piece formed such that an approximately L-shaped tongue piece extended from an end of an installation surface of the second part is bent at approximately a right angle with respect to the installation surface; and a projection part that is provided on either the installation surface of the second part or the first tongue piece, and that are brought into contact with an opposed surface to apply a pressure thereto when the first part is installed to the second part by sandwiching the first tongue piece between the installation surface of the second part and the second tongue piece.

### Effect of the Invention

According to the present invention, there is an advantageous effect such that the parts can be stably installed to each other without using fastening parts.

### BRIEF DESCRIPTION OF THE DRAWINGS

FIG. 1 is a perspective view showing a conventional part installation structure.

FIG. 2 is a perspective view showing a part installation structure according to Embodiment 1 of the present invention.

FIG. 3 is a view showing main parts of the part installation structure according to Embodiment 1.

FIG. 4 is a perspective view showing a part installation structure according to Embodiment 2 of the invention.

FIG. 5 is a view showing main parts of the part installation structure according to Embodiment 2.

FIG. 6 is a view showing another mode of the part installation structure according to Embodiment 2.

FIG. 7 is a perspective view showing a part installation structure according to Embodiment 3 of the invention.

FIG. 8 is a view showing still another mode of the part installation structure according to Embodiment 3.

### BEST MODE FOR CARRYING OUT THE INVENTION

In the following, in order to describe the present invention in more detail, embodiments for carrying out the invention will be described with reference to the accompanying drawings.

### Embodiment 1

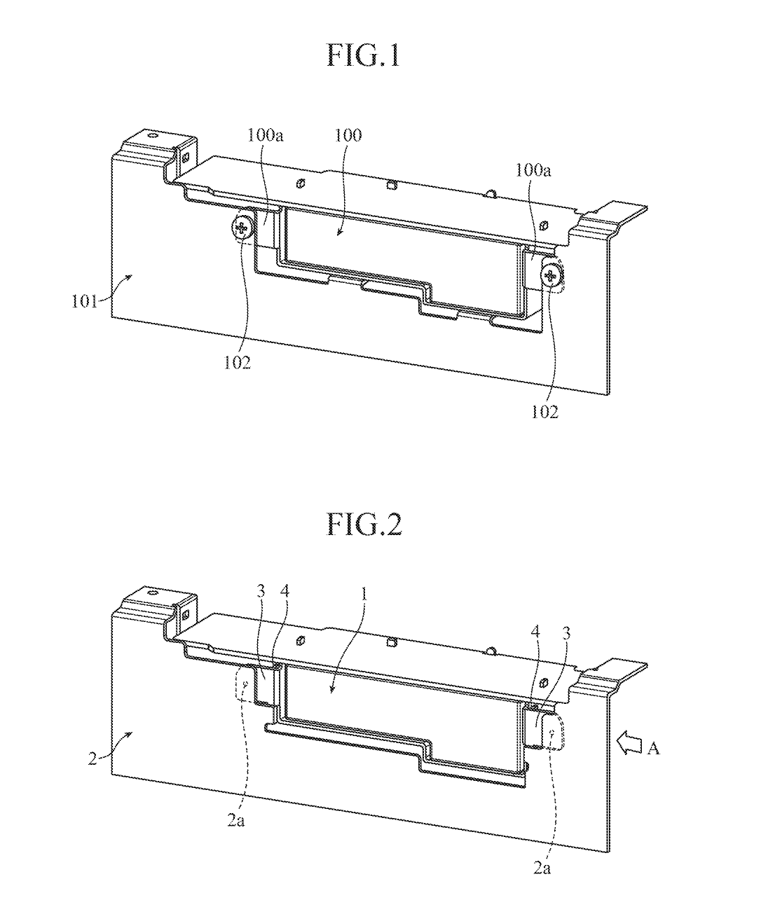

FIG. 1 is a perspective view showing a conventional part installation structure. As shown in FIG. 1, a sheet metal part 100 has tongue pieces 100a formed such that sheet-shaped tongue pieces each are bent at approximately a right angle with respect to a base of the part, the tongue pieces being connected to both sides of one surface of the part. In addition, one surface of a sheet metal part 101 provides an installation surface for installing the sheet metal part 100 via the tongue pieces 100a.

In the example of FIG. 1, in order to expose an external connector and so on provided on the above one surface of the sheet metal part 100 to the outside of a device, notched is a portion of the above installation surface of the sheet metal part 101 that is opposed to the above one surface of the sheet metal part 100 when installing the sheet metal part 100.

Both the tongue pieces 100a of the sheet metal part 100 and the installation surface of the sheet metal part 101 are made of sheet metal, and therefore, in the present invention, parts that have installation members made of sheet metal will be called sheet metal parts.

In the conventional installation structure, as shown in FIG. 1, generally the tongue pieces 100a of the sheet metal part 100 and the installation surface of the sheet metal part 101 are installed with fastening parts such as screws 102. In this case, it is necessary to form through-holes on the installation surface of the sheet metal part 101, and form tapped screw holes on the tongue pieces 100a.

In addition, in order to perform the installation at both sides of the above one surface of the sheet metal part 100 via the tongue pieces 100a, it is necessary to precisely align the through-holes that are formed on the installation surface of the sheet metal part 101 with the screw holes of the tongue pieces 100a that correspond to the through-holes.

Further, when installing the sheet metal part 100 to the sheet metal part 101, it is necessary to perform the fastening using the screws 102 while maintaining a state that the through-holes on the installation surface of the sheet metal part 101 are matched with the screw holes of the tongue pieces 100a. Therefore, there is a limit to the handling during the installation.

Accordingly, the present invention proposes a structure for stably installing the sheet metal parts to each other without using the fastening part. Employment of this structure can omit the processing that requires precision as described above, and also facilitates the installation.

FIG. 2 is a perspective view showing a part installation structure according to Embodiment 1 of the present invention. A sheet metal part 1 shown in FIG. 2 has tongue pieces 3 formed such that sheet-shaped tongue pieces each are bent at approximately a right angle with respect to a base of the part, the tongue pieces being connected to both sides of one surface of the part, in a similar manner to the sheet metal part 100 in FIG. 1. In addition, one surface of a sheet metal part 2 provides an installation surface for installing the sheet metal part 1 via the tongue pieces 3.

In FIG. 2, also, in order to expose an external connector and so on provided on the above one surface of the sheet metal part 1 to the outside of a device, notched is a portion of the above installation surface of the sheet metal part 2 that faces the above one surface of the sheet metal part 1 when installing the sheet metal part 1.

As a characteristic configuration in the present invention, the sheet metal part 2 has tongue pieces 4 formed such that approximately L-shaped tongue pieces each are bent at approximately a right angle with respect to the installation surface of the part, the tongue pieces being extended from ends of the corresponding installation surface.

Further, on the installation surface of the sheet metal part 2, there are formed projection parts 2a which are brought into contact with a facing surface to apply a pressure to the facing surface, when the sheet metal part 1 is installed to the sheet metal part 2 by sandwiching the tongue piece 3 between the installation surface of the sheet metal part 2 and the tongue piece 4.

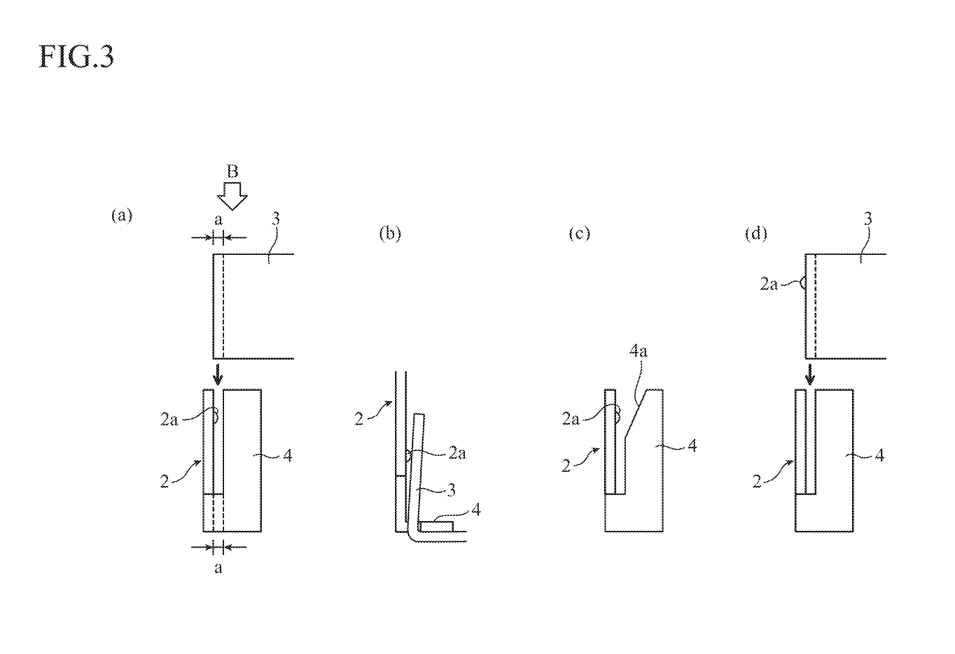

FIG. 3 is a view showing main parts of the part installation structure according to Embodiment 1. FIG. 3(a) shows an installation mode of the sheet metal parts 1 and 2, and is a view on arrow viewed from an arrow A direction described in FIG. 2. In addition, FIG. 3(b) is a view of a state in which the sheet metal parts 1 and 2 are installed when viewed from an arrow B direction described in FIG. 3(a).

As shown in FIG. 3(a), when the approximately L-shaped tongue piece extended from an end of the installation surface of the sheet metal part 2 is bent at approximately a right angle with respect to the installation surface, the tongue piece 4 is formed such that a distance between the installation surface and an end surface of the tongue piece 4 becomes a when viewed from the arrow A direction, that is, the distance is almost the same level as a thickness of the tongue piece 3 of the sheet metal part 1. With such a configuration, when the sheet metal part 1 is installed to the sheet metal part 2 by sandwiching the tongue piece 3 between the installation surface of the sheet metal part 2 and the tongue piece 4, the projection part 2a is brought into contact with a facing surface of the tongue piece 3 to apply a pressure to the facing surface. By virtue of the applied pressure, as shown in FIG. 3(b), portions of the installation surface of the sheet metal part 2 facing the tongue pieces 3 at both sides of the sheet metal part 1 are respectively elastically deformed, and a holding force for the tongue piece 3 by the installation surface of the sheet metal part 2 and the tongue piece 4 increases.

Further, as shown in FIG. 3(b), when the sheet metal parts 1 and 2 are installed, the tongue pieces 4 of the sheet metal part 2 are brought into contact with bases of the tongue pieces 3 at both sides of the sheet metal part 1. With this arrangement, the tongue pieces 4 work as stoppers, and regulate a move of the sheet metal part 1 to sideways, so that the sheet metal part 1 will not be backlashed to both sides.

Moreover, in order to smoothly sandwich the tongue piece 3 between the installation surface of the sheet metal part 2 and the tongue piece 4, an inclined surface 4a as shown in FIG. 3(c) may be formed on the tongue piece 4. Even when a lower part of the tongue piece 3 is brought into contact with the inclined surface 4a when installing the sheet metal part 1 to the sheet metal part 2, the lower part of the tongue piece 3 moves by sliding along the inclined surface 4a, and the tongue piece 3 is guided between the installation surface of the sheet metal part 2 and the tongue piece 4. With this configuration, the sheet metal parts 1 and 2 can be installed more easily.

Additionally, the projection part 2a for stabilizing the installation may be provided at the side of the tongue piece 3, as shown in FIG. 3(d). With such a configuration, the projection part 2a of the tongue piece 3 is also brought into contact with the installation surface of the sheet metal part 2 facing the projection part 2a to apply a pressure to the installation surface. Therefore, the holding force for the tongue piece 3 by the installation surface of the sheet metal part 2 and the tongue piece 4 increases, so that a stable installation becomes possible.

As described above, according to Embodiment 1, the part installation structure includes: the tongue piece 3 formed such that the sheet-shaped tongue piece provided in the sheet metal part 1 is bent at approximately a right angle to the base connected to the sheet metal part 1; the tongue piece 4 formed such that the approximately L-shaped tongue piece extended from the end of the installation surface of the sheet metal part 2 is bent at approximately a right angle to the installation surface; and the projection part 2a that is provided on either the installation surface of the sheet metal part 2 or the tongue piece 3, and that is brought into contact with the facing surface to apply the pressure thereto when the sheet metal part 1 is installed to the sheet metal part 2 by sandwiching the tongue piece 3 between the installation surface of the sheet metal part 2 and the tongue piece 4.

With such a configuration, the sheet metal part 1 can be installed to the sheet metal part 2 by only sandwiching the tongue piece 3 between the installation surface of the sheet metal part 2 and the tongue piece 4 without using a fastening part, so that the easy installation becomes possible. Further, because the projection part 2a is brought into contact with the facing surface to apply the pressure thereto when the sheet metal part 1 is installed to the sheet metal part 2, the sheet metal parts 1 and 2 can be stably installed to each other by elastic deformation of the facing surface.

Further, according to Embodiment 1, because the tongue piece 4 has the inclined surface 4a for guiding the tongue piece 3 into between the installation surface of the sheet metal part 2 and the tongue piece 4, a quick installation work becomes possible without requiring an elaborate correction work.

### Embodiment 2

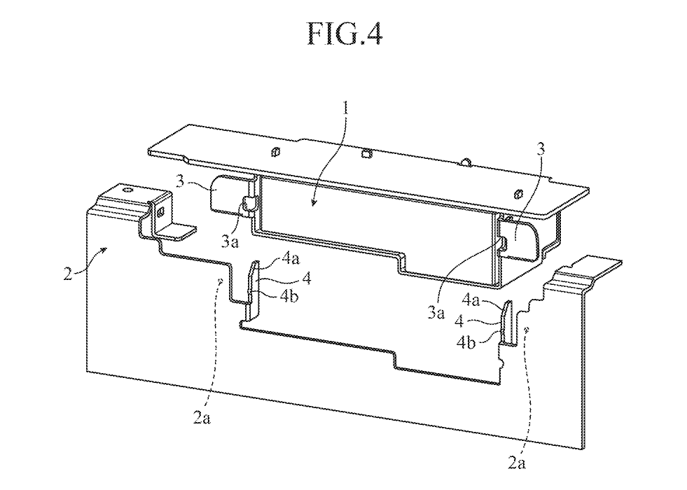

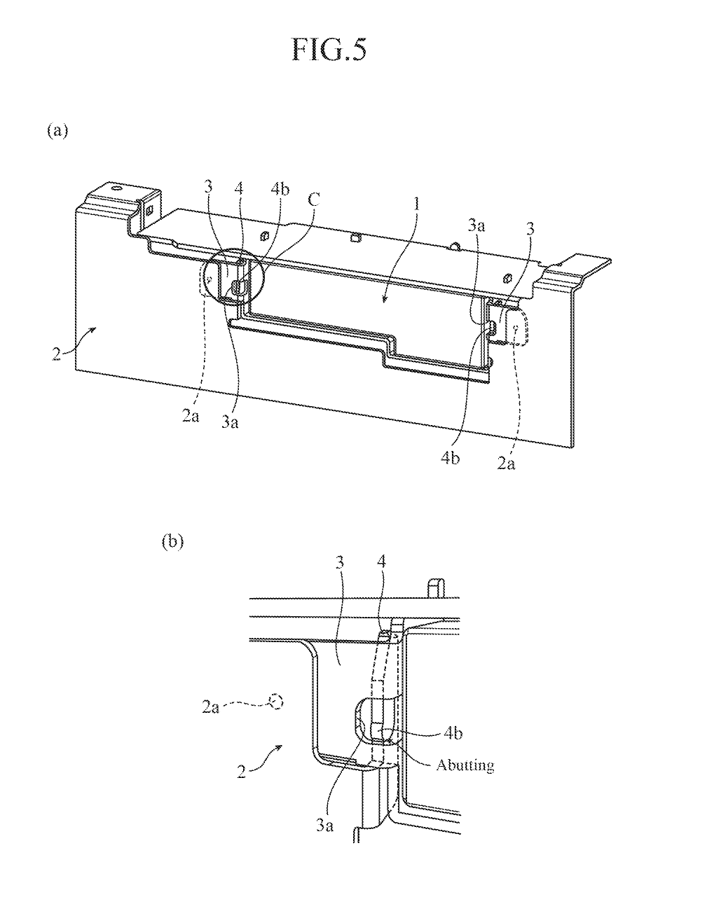

FIG. 4 is a perspective view showing a part installation structure according to Embodiment 2 of the present invention. FIG. 5 is a view showing main parts of the part installation structure according to Embodiment 2. FIG. 5(a) is a perspective view showing a state that sheet metal parts 1 and 2 are installed. FIG. 5(b) is an enlarged view of a portion attached with a sign C of FIG. 5(a) . As shown in FIG. 4, a fitting hole 3a is formed near the base of a tongue piece 3 of the sheet metal part 1 according to Embodiment 2. In addition, on a tongue piece 4 of the sheet metal part 2, there is formed a fitting projection part 4b that is fitted into a fitting hole 3a when the tongue piece 3 is sandwiched between the installation surface of the sheet metal part 2 and the tongue piece 4. In FIG. 4 and FIG. 5, components having the same functions as those in FIG. 2 are denoted by the same signs, and descriptions thereof will be omitted.

As shown in FIG. 5(a), when the tongue piece 3 is sandwiched between the installation surface of the sheet metal part 2 and the tongue piece 4, the fitting projection part 4b is fitted into the fitting hole 3a.

Specifically, when the tongue piece 3 is pressed into between the installation surface of the sheet metal part 2 and the tongue piece 4, first, a lower part of the tongue piece 3 is brought into contact with (abutted on) an upper part of the fitting projection part 4b. When the sheet metal part 1 is further pressed in this state, the lower part of the tongue piece 3 rides on the fitting projection part 4b, and finally, the fitting projection part 4b is fitted with the fitting hole 3a. Then, the installation is completed.

When the lower part rides on the fitting projection part 4b, elastic deformation force occurs in the tongue piece 3. When the fitting projection part 4b is fitted into the fitting hole 3a, the elastic deformation force is released in a breath, and an insertion feeling is obtained with a snapping sound. With this arrangement, an operator can grasp completion of the installation of the sheet metal parts 1 and 2 on the basis of the above insertion feeling, whereby fitting failure during the installation can be prevented.

Further, in order to facilitate the riding of the lower part of the tongue piece 3 onto the fitting projection part 4b, an inclined surface that is inclined to a direction of pressing the tongue piece 3 (the arrow B direction in FIG. 3(a)) during the installation of the sheet metal parts 1 and 2 may be formed on the fitting projection part 4b. With this arrangement, the lower part of the tongue piece 3 can be pressed by sliding along the inclined surface.

In addition, the lower part of the fitting projection part 4b is fitted into the fitting hole 3a in a state abutting on the inner wall part of the fitting hole 3a that is opposed to the lower part, as shown in FIG. 5(b). With this arrangement, a move of the tongue piece 3 to a direction deviating from between the installation surface of the sheet metal part 2 and the tongue piece 4 is regulated, which makes possible a firmer installation as compared with the configuration of Embodiment 1.

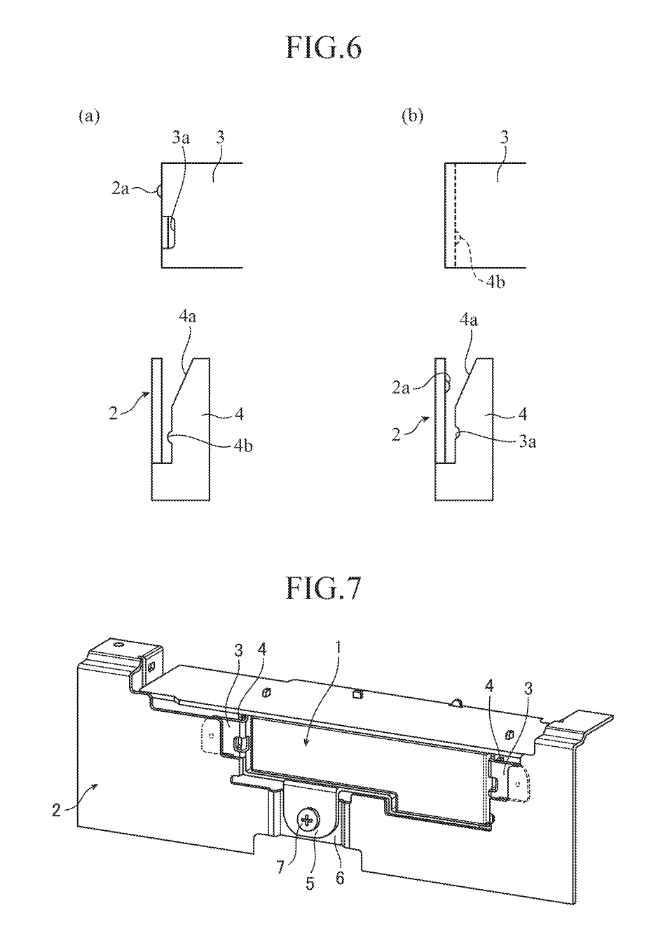

FIG. 6 is a view showing another mode of the part installation structure according to Embodiment 2, and is a view on arrow viewed from the arrow A direction described in FIG. 2.

In the structure formed with the fitting hole 3a and the fitting projection part 4b, the projection part 2a for stabilizing the installation may be also provided at the side of the tongue piece 3, as shown in FIG. 6(a).

With such a configuration, the projection part 2a of the tongue piece 3 is also brought into contact with the installation surface of the sheet metal part 2 that is opposed to the projection part to apply a pressure to the installation surface. Therefore, a holding force for the tongue piece 3 by the installation surface of the sheet metal part 2 and the tongue piece 4 increases, so that a stable installation becomes possible.

In addition, an inclined surface 4a as shown in FIG. 6(a) and FIG. 6(b) may be formed in the tongue piece 4 such that the tongue piece 3 is smoothly held between the installation surface of the sheet metal part 2 and the tongue piece 4.

Further, as shown in FIG. 6(b), the fitting hole 3a may be formed on an end surface part of the tongue piece 4, and the fitting projection part 4b may be formed on the end surface part of the tongue piece 3 that is opposed to the end surface part of the tongue pieces 4. With such a configuration, when the fitting projection part 4b of the tongue piece 3 slides on the end surface of the tongue piece 4, elastic deformation force also occurs in the tongue piece 3; when the fitting projection part 4b is fitted into the fitting holes 3a, the elastic deformation force is released in a breath, so that an insertion feeling can be generated. Further, even by fitting the fitting projection part 4b of the tongue piece 3 into the fitting hole 3a, a move of the tongue piece 3 to a direction deviating from between the installation surface of the sheet metal part 2 and the tongue piece 4 is regulated, so that a firmer installation becomes possible.

As described above, according to Embodiment 2, the part installation structure includes: the fitting hole 3a that is provided on either the tongue piece 3 or the tongue piece 4; and the fitting projection part 4b that is provided on either the tongue piece 3 or the tongue piece 4, and that regulates a move of the tongue piece 3 to a direction deviating from between the installation surface of the sheet metal part 2 and the tongue piece 4 by being fitted into the fitting hole 3a when the tongue piece 3 is sandwiched between the installation surface of the sheet metal part 2 and the tongue piece 4. With such a configuration, when the fitting projection part 4b is fitted into the fitting hole 3a, the insertion feeling attributable to the elastic deformation force of the tongue piece 3 can be generated, so that an operator can easily grasp the completion of the installation. Further, the fitting projection part 4b regulates the move of the tongue piece 3 to the direction deviating from between the installation surface of the sheet metal part 2 and the tongue piece 4, so that an even firmer installation becomes possible as compared with the configuration of Embodiment 1.

### Embodiment 3

FIG. 7 is a perspective view showing a part installation structure according to Embodiment 3 of the present invention. As shown in FIG. 7, in Embodiment 3, there are provided a tongue piece 5 and an installation surface 6 that fix a state that a sheet metal part 1 is installed to a sheet metal part 2 by sandwiching a tongue piece 3 between an installation surface of the sheet metal part 2 and a tongue piece 4. Additionally, in FIG. 7, components having the same functions as those in FIGS. 2 and 4 are denoted by the same signs, and descriptions thereof will be omitted.

In the example shown in FIG. 7, the tongue piece 5 is provided at a lower part of one surface of the sheet metal part 1 where the tongue piece 3 is provided. The installation surface 6 is provided at a position of the sheet metal part 2 that is opposed to the tongue piece 5 when the sheet metal parts 1 and 2 are installed. A through-hole for piercing through a screw 7 is formed on the tongue piece 5, while a screw hole to be meshed with the screw 7 is formed on the installation surface 6.

The through-hole and the screw hole are formed such that positions of the through-hole and the screw hole are matched together in a state that the sheet metal part 1 is installed to the sheet metal part 2 by sandwiching the tongue piece 3 between the installation surface of the sheet metal part 2 and the tongue piece 4. In this state, the fastening is established by the screw 7.

That is, due to the configurations of the above Embodiments 1 and 2, the sheet metal part 1 can be fastened to the sheet metal part 2 in a state where the sheet metal part 1 is stably installed to the sheet metal part 2, and thus there is no limit to the handling in performing a fastening work unlike the conventional.

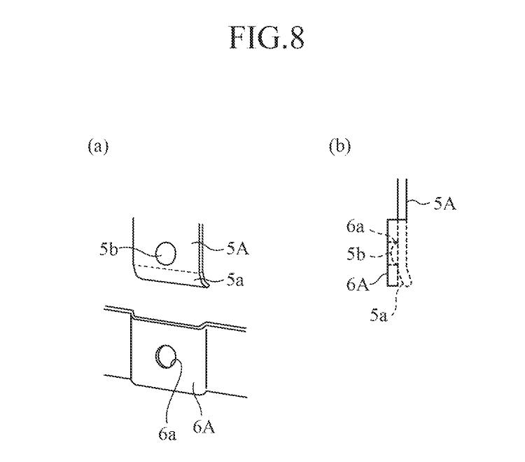

Additionally, a fixing part can also be provided in a configuration not using a fastening part, as shown in FIG. 8. In the example of FIG. 8(a), the tongue piece 5 constituting the fixing part is a tongue piece 5A formed with a fitting projection part 5b, and the installation surface 6 of the sheet metal part 2 is an installation surface 6A formed with a fitting hole 6a that is fitted with the fitting projection part 5b. When the sheet metal parts 1 and 2 is installed, as shown in FIG. 8(b), the fitting projection part 5b of the tongue piece 5A is fitted into the fitting hole 6a of the installation surface 6A, and an installation state of the sheet metal parts 1 and 2 is fixed.

Additionally, the following configuration is shown: the fitting projection part 5b is formed on the tongue piece 5A, and the fitting hole 6a is formed on the installation surface 6A; however, the fitting hole 6a may be formed on the tongue piece 5A, and the fitting projection part 5b may be formed on the installation surface 6A. With such a configuration, an effect similar to the above can be obtained.

As described above, according to Embodiment 3, there are provided the tongue piece 5 and the installation surface 6 serving as the fixing part that fixes a state that the sheet metal part 1 is installed to the sheet metal part 2 by sandwiching the tongue piece 3 between the installation surface of the sheet metal part 2 and the tongue pieces 4. Therefore, as compared with the configurations in Embodiments 1 and 2, the sheet metal parts 1 and 2 can be installed more firmly.

Incidentally, in the present invention, a free combination in the embodiments, a modification of arbitrary components in the embodiments, or an omission of arbitrary components in the embodiments is possible within a range of the invention.

### INDUSTRIAL APPLICABILITY

In the part installation structure of the present invention, the parts can be stably installed to each other without using fastening parts, and it is thus suitable for various information devices such that the parts are installed to each other using sheet-metal installation members.

### EXPLANATION OF REFERENCE NUMERALS

1, 2 SHEET METAL PART

3, 4, 5, 5A TONGUE PIECES

2a PROJECTION PART

3a, 6a FITTING HOLES

4a INCLINED SURFACE

4b, 5b FITTING PROJECTION PARTS

6, 6A INSTALLATION SURFACES

7 SCREW.

1. A part installation structure for installing a first part to a second part, comprising:
a first tongue piece formed such that a sheet-shaped tongue piece provided in the first part is bent at approximately a right angle with respect to a base that is connected to the first part;
a second tongue piece formed such that an approximately L-shaped tongue piece extended from an end of an installation surface of the second part is bent at approximately a right angle with respect to the installation surface; and
a projection part that is provided on either the installation surface of the second part or the first tongue piece, and that is brought into contact with an opposed surface to apply a pressure thereto when the first part is installed to the second part by sandwiching the first tongue piece between the installation surface of the second part and the second tongue piece.

2. The part installation structure according to claim 1, wherein the second tongue piece has an inclined surface that guides the first tongue piece between the second tongue piece and the installation surface of the second part.

3. The part installation structure according to claim 1, comprising:
a fitting hole that is provided on either the first tongue piece or the second tongue piece; and
a fitting projection part that is provided on either the first tongue piece or the second tongue piece, and that regulates a move of the first tongue piece to a direction deviating from between the installation surface of the second part and the second tongue piece by being fitted into the fitting hole when the first tongue piece is sandwiched between the installation surface of the second part and the second tongue piece.

4. The part installation structure according to claim 1, comprising a fixing part that fixes a state in which that the first part is installed to the second part by sandwiching the first tongue piece between the installation surface of the second part and the second tongue piece.
